(19) United States
(12) Patent Application Publication
(10) Pub. No.: US 2004/0260607 A1
(43) Pub. Date: Dec. 23, 2004

(54) Stored product personal identification system

(76) Inventors: Andrew H. Robbins, Newton, MA (US); David Foulser, Melrose, MA (US)

Correspondence Address: FISH & RICHARDSON PC, 225 FRANKLIN ST, BOSTON, MA, 02110, US

(21) Appl. No.: 10/766,517

(22) Filed: Jan. 28, 2004

Related U.S. Application Data
(60) Provisional application No. 60/443,026, filed on Jan. 28, 2003.

(51) Int. Cl. G06F 17/60

(52) U.S. Cl. 705/14; 705/15

(57) ABSTRACT

A method includes receiving a request for a product, receiving a unique user identification, sending the product request and user identification to a database server, processing the product request and user identification in conjunction with a set of rules in the database server, and storing the product request on a device associated with the user identification.

### CROSS-REFERENCE TO RELATED APPLICATION

This application claims benefit of priority from U.S. Provisional Application entitled “Stored Product Personal Identification System,” filed Jan. 28, 2003, application Ser. No. 60/443,026.

### TECHNICAL FIELD

This invention relates to stored product personal identification system.

### BACKGROUND

Retail and restaurant industries offer customers customer cards, loyalty cards and/or gift cards on which a dollar value amount can added to the customer, loyalty and/or gift card and later used by the same customer or another customer to purchase goods or services. This is sometimes referred to as stored value. For example, gift cards have become one of the fastest growing trends in the retail industry. Gift cards often replace paper gift certificates and have a variety of benefits. Some of these gift card benefits include an ability to track gift cards individually from time of purchase through redemption and depletion of value, and greater security in that they are more difficult to copy and replicate, thus reducing the possibility of fraud. Because gift cards are more secure, they can be promoted at a point-of-sale (POS).

The industry has labeled gift card technology as stored value cards because dollar value is stored. Typically, cards are activated at a POS terminal with a preset amount (e.g., fixed value cards) or a variable amount entered by a cashier (e.g., variable cards). The cashier will add money to the card at the POS terminal and the customer pays for the card. The value can be stored on the card (e.g., Smart Card), or more prevalently, the value is stored in a centralized database with an account associated with a card number. The customer can then keep the card for themselves or give it as a gift to another individual. The receiver of the card can then use this card to pay for goods or services at any store operated by the merchant from whom the card was purchased.

The card is redeemed in a method similar to a credit card or debit card transaction. The cashier enters all of the items into the POS terminal. The cashier goes to a pay or tender screen on the terminal. The cashier requests to pay using the stored value or gift card. The card is read by a magnetic stripe reader (or bar code or manually entered or smart card reader). A message is sent to a back-end database that authorizes the transaction up to the valid amount on the card. The card balance in the database is reduced by the redemption amount. A tender item is added to the check by the redemption amount.

### SUMMARY

In an aspect, the invention includes a method including receiving a request for a product, receiving a unique user identification, sending the product request and user identification to a database server, processing the product request and user identification in conjunction with a set of rules in the database server, and storing the product request on a device associated with the user identification.

In embodiments, the product request can be a specific menu item, a specific stock keeping unit (SKU), a family of menu items, a family of SKU items and/or a category. The category can be a number of families and/or a number of SKU items. The product request can be a specific menu item.

The stored product request can represent a number of items, a percentage discount of an item, a dollar discount of an item, a dollar discount of a number of items, and/or a percentage discount of an item.

Storing can also include adding additional product, and/or adding rewards. Sending can include variable length messages.

The method can include performing a check-level reconciliation. The request can originate for a point-of-sale (POS) terminal, from remote network terminal, and/or from a kiosk.

The device can be loyalty card, a Personal Data Assistant (PDA), a payment card, and/or a smart card.

In another aspect, the invention features a system including a point-of-sale (POS) terminal having a POS database, a link to a server database having rules, and a link to a device for uniquely identifying a user and for storing a product representation.

Embodiments of the invention can have one or more of the following advantages. A stored product personal identification system allows a retailer or restaurant to provide stored product capability. This enables a merchant to provide customers a plastic magnetic stripe card or other identification device, which is used to add, store and later redeem products and/or services. The system can be used as part of a stored value, gift card, loyalty and or other form of loyalty payment gateway system. This system introduces a stored product and stored product card (stored product rules, stored product database using multiple wallets).

The system provides an ability to store product on an identification device or on a database account associated with the identification device, such as magnetic strip cards, bar codes, payment cards, debit cards, RFID tag, PDAs, username and password combinations, Smart cards, cell phones, finger print and iris scan systems.

The system provides an ability to store product as a number of items, as a percent off of an item, as a dollar amount off of an item or as a dollar amount off of a group of items. Product can be a specific menu item or Stock Keeping Unit (SKU), a family of menu items or SKUs, and/or a category that includes multiple families and their respective menu items or SKUs.

The system provides an ability to add product or rewards from Point-of-Sale (POS) from a menu list, or usage of pop-up buttons, in which list and buttons can be defined centrally and deployed automatically to POS systems. The system provides an ability to insert line items and prices into a POS database and check, to print purchased rewards or items onto a receipt with the purchase, and an ability to print a special gift receipt to go with the card to the recipient of the gift.

The system provides an ability to send messages from the POS to a back-end database that authorizes a transaction. This ability takes advantage of a messaging structure with variable format, ability to add and invoke rules engine rules, ability to manage many wallets, ability to define the contents of wallets, ability to define how a wallet should be treated at POS (e.g., what information should be extracted from the check and what items should be inserted into the check on reply), can remain synchronized in communication and point out variant transactions, provide transaction limits, and can authorize in full, in part or deny the transaction, and update the database record associated with the card to have the product.

The system provides an ability to give access to the stored product or rewards via inquiry at the POS, via inquiry from a telephone, via a web interface and via other computer interfaces, such as kiosks, auction software, call centers and Customer Relationship Management (CRM) applications.

The system provides an ability to redeem the rewards from a POS through messaging, and can restrict requests to items in the check, run rules, authorize in full or in part, or deny, and update account records.

The system provides an ability to perform check level reconciliation and replaces an industry practice of daily or shift-based batch reconciliation with check-level reconciliation.

The system provides an ability to run real-time rules. Real-time rules can depend on card template, merchant, store location, time of day, date of issue, account tier, wallet values in account, and card holder information such as birth date. These rules run during a POS transaction request and take approximately less than 1 second to execute. Examples of real-time rules are expiration of free products based on:

(1) Free Gift rule (Add $50 to card and get 1 Free Entrée)

(2) Birthday rule: special product reward on person's birthday, week of birthday or month of birthday.

(3) Buy X get Y Free

a. Buy 9 coffees and get 1 free coffee

b. Buy 2 Entrees and get 2 appetizers free

(4) Purchase rewards from points

(5) Ladder of rewards rule

(6) Roulette Rule

a. Every 200^{th} customer gets a reward (e.g. a cookbook signed by chef)

b. A random number is generated with each transaction and is checked vs. a predefined X% of purchasers

(7) Bingo Rule—Go to each one the merchant's locations defined in total or by concept group and win special reward.

(8) Conversion of monthly reward to product reward based on

The system provides an ability to run batch rules. Batch rules can depend on card template, merchant, store location, state of store location, date of issue and card holder information such as birth date. Examples of batch rules are:

(1) Expiration of stored product based on expiration date.

(2) Expiration of stored product based on time period from date of purchase.

(3) Expiration of stored product based on time period from date of last use.

(4) Expiration of stored product based on expiration of club membership.

(5) Expiration of stored product based on merchant analysis rules.

(6) Expiration can be all at once or rate limited e.g., expire one reward per month.

(7) Product added on a periodic basis based on club membership rules.

a. One Free Coffee added per month for 12 months.

b. Calendar based rewards: January=3 Free Games of Bowling; February=1 Free Appetizer, March=2 Free Deserts, April=$5 Free Game play.

(8) Products added based on merchant analytical rules:

a. Give Free Gift offer to customers who have not come in the last 6 weeks.

b. Give Free Wine Tasting offer to customers who have spent over $500.

(9) Sweepstakes type rule that does an electronic drawing for rewards based on cumulative purchase information from accounts.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a network.

FIG. 2 is a diagram of a hierarchy.

FIG. 3 is a diagram of a user interface.

FIG. 4 is a flow diagram of process.

FIGS. 5-12 are exemplary user interfaces.

FIG. 13 is a block diagram.

FIG. 14 is a block diagram

FIGS. 15-17 are exemplary user interfaces.

FIG. 18 is a flow diagram.

FIG. 19 is a diagram of rules.

FIG. 20 is a block diagram.

Like reference symbols in the various drawings indicate like elements.

### DETAILED DESCRIPTION

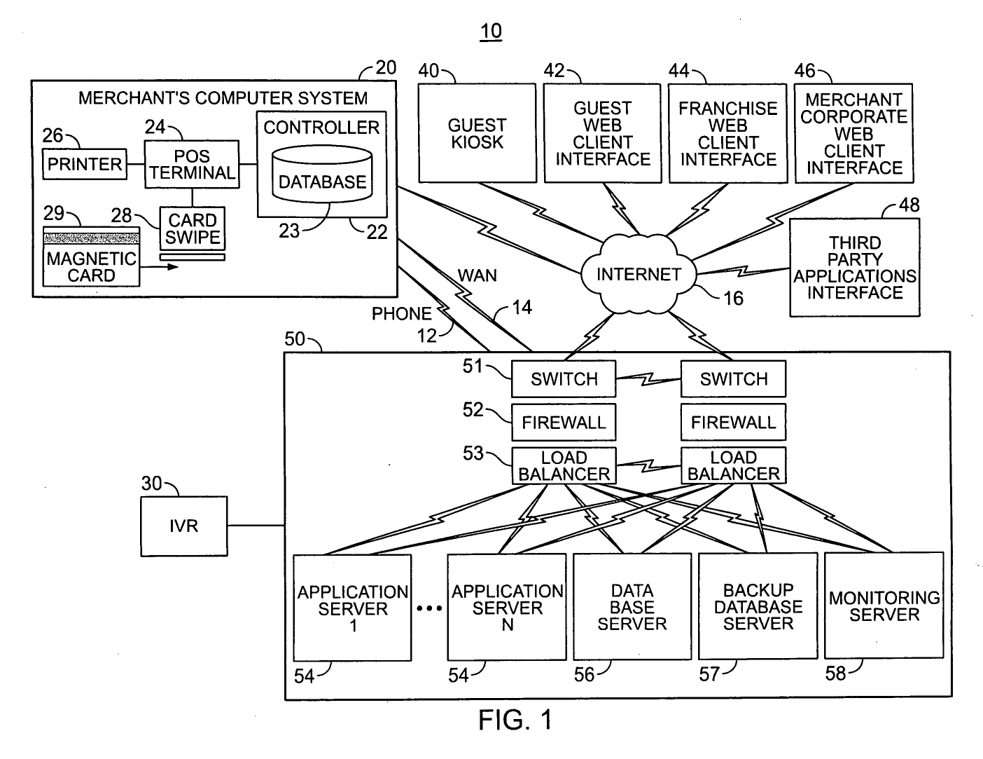

A restaurant chain utilizes a point-of-sales (POS) system to enter guest orders, make the order, track food inventory, take guest payment and track financials. As shown in FIG. 1, a network 10 includes a merchants computer system 20 linked via a Wide Area network (WAN) 14, phone 12, or internet 16 to guest loyalty and marketing system 50.

At the store or restaurant, a cashier presses a button on a POS terminal 24 to initiate a guest loyalty or payment transaction. The guest identifies themselves with a magnetic stripe card 29 that is read by a card reader 28 attached to POS terminal 24. A message is passed to a controller 22 that manages secure communication to the guest loyalty and marketing system 50. The system returns information with four elements: information about the guest (name, tier, balances), items to be added to the check on terminal 24 (menu items, tender items, discounts and service charges), messages for the cashier to appear on the screen of the terminal 24, messages for the guest receipt printed on printer 26.

The network 10 includes a guest interface via a touch screen kiosk 40 where the guest can register personal information to their account, get their account balances, and redeem rewards to a printed voucher.

The network 10 includes a guest web client interface 42 via a web browser that enables the guest to register, edit their account information, get account balances, view account transaction history, view and edit their favorite order, verify their e-mail address, sign-up for automatic recharge, choose program options, redeem rewards, report a lost or stolen card.

The network 10 includes a merchant corporate web client interface 46 via a web browser that enables corporate staff to perform various reconciliation, guest customer service functions, reporting and analysis and market promotions.

The network 10 includes a franchisee client interface 44 via a web browser that enables franchisees to perform various check the status of the day's activities, review pending movement of money to and from a central corporate account, and corporate sanctioned guest marketing activities.

The network 10 includes an IVR interface 30 which allows telephone based access to the hosted solution. The IVR interface 30 includes guest specific information such as account balances and information on how register a card or report a lost card. The IVR interface 30 includes a restaurant staff interface to check guest account balances, perform transactions when the controller 22 is unable to communicate over the WAN 14 or internet 16.

The network 10 includes an interface for third party software applications 48. Third party software applications can connect via a secure messaging protocol over WAN 14 or internet 16. The messaging protocol enables the third party software application to access guest information,

Communications to system 50 enters front-end networking equipment which includes switches 51, firewalls 52, and load balancers 53. This networking equipment provides scalability, reliability, redundancy and fault tolerance. Guest identification, rules processing, web interfaces, reporting and other features are processed across multiple application servers 54. Guest data, transactions and merchant rules are stored in redundant databases 56 and 57. A monitoring server 58 provides internal monitoring of the hosted solution equipment and software.

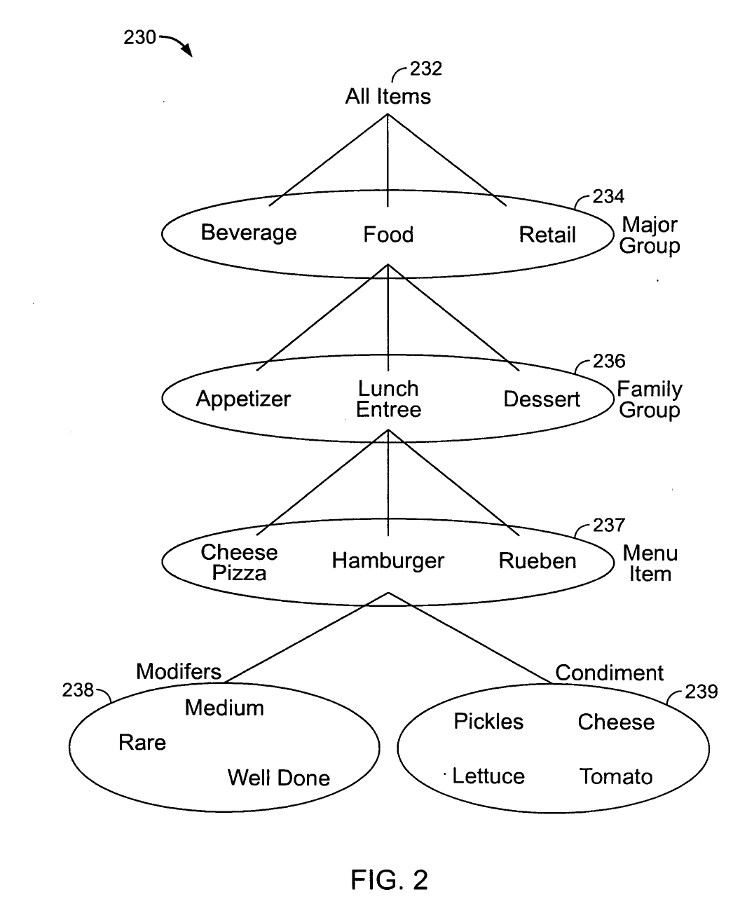

As shown in FIG. 2, a restaurant's systems organizes menu information in a hierarchy 230. At the highest level are all items 232. Items are then broken into categories or major groups 234. Examples of major groups can be food, beverages, retail, and miscellaneous. The next level down are family groups 236. The food major group can have families that include: appetizers, lunch entrées, dinner entrées, side items, and desserts. Each family includes specific menu items 237. The lunch entrée family can contain the following menu items: cheese pizza, pepperoni pizza, hamburger and Rueben. The order of a menu item can require or have as options condiments 238 and/or modifiers 239. When a hamburger is ordered examples of modifiers and condiments are rare and cheddar cheese, respectively. System 10 takes advantage of the menu item hierarchy.

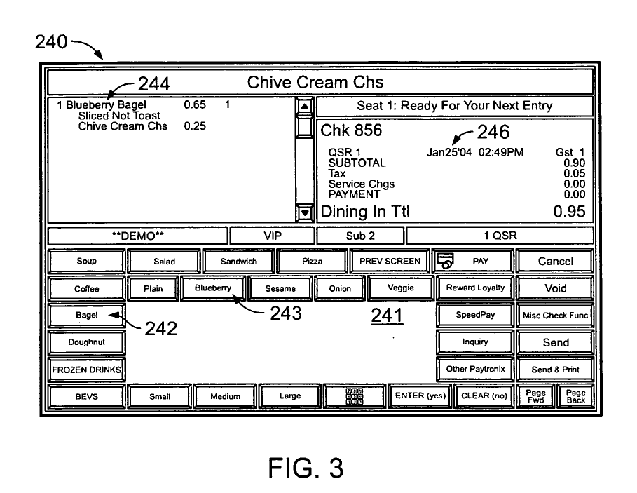

As shown in FIG. 3, a restaurant's POS terminal has a user interface 240. The user interface 240 has buttons in area 241 that enable the cashiers to log-in, navigate through to different screens, add menu items, modifiers and condiments, perform check functions such as send, cancel, void, pick-up check, and so forth, add payment items such as different tenders (cash, credit card, gift card), add service charges such as tip and sales of gift cards, and perform managerial tasks such as reporting, reconciliation tasks, and system maintenance.

In this example, button 242 brings the cashier to a screen with menu items belonging to the family group bagels. Button 243 inserts a menu item “Blueberry Bagel” into the check. The list of check details is shown in area 244. In this case a modifier “sliced no toast” and a condiment “chive cream cheese” were added to the check. Area 245, shows check summary information such as check number, sub-total, tax, tip, total and payment information. System 50 integrates into the POS with buttons that perform system activities such as getting an account balance inquiry or paying with a gift card.

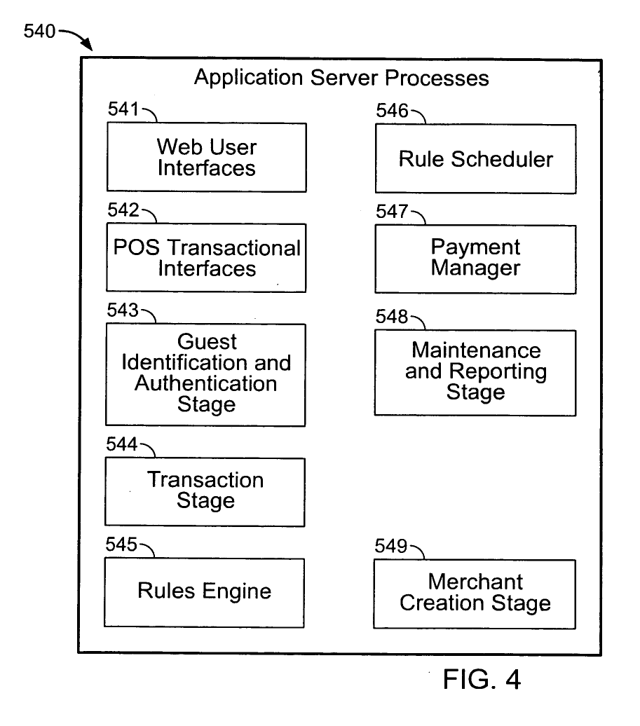

The processes of the application server 54 are described with reference to FIG. 4. Referring now to FIG. 4, the application server processes 540 include web user interfaces 541, POS transactional interfaces 542, Guest identification stage 543, Transactional Stage 544, Rules Engine 545, Rules Scheduler 546, Payment Manger 547, Maintenance and Reporting stage 548 and Merchant Creation Interface 549.

Web user interfaces 541 manages several web client interfaces to the system 50. These interfaces include the guest web client 42, the guest kiosk 40, the franchisee web client 44, the merchant corporate web client 26, the IVR interface 30, and the integrations to third party applications 48. The web user interface 541 provides access to guest account information, merchant set-up and status information, and merchant use reports in the database 56.The web user interface 541 also provides a transaction connection to the transaction stage 544 and rules engine 545.

The maintenance and reporting stage 548 is responsible for the maintenance of the system 50 and preparing transaction reports. This stage 548 provides status and alerts for errors within the system 50 operations and connectivity issues with restaurant locations and stores. In addition, the maintenance and reporting stage 548 manages generation of preferred payment information, reset of preferred payment information, reporting and reconciliation of transaction with restaurants and reconciliation of payments with an Enterprise Resource Planning (ERP) system (if installed).

The majority of system 50 activity comes from the POS systems 20. These inquiries or authorizations enter through the POS transactional interface 542. This interface 542 authenticates the POS system 20 through a combination of one or all of the following—certificates, credentials, terminal ID or username and password. This interface 542 manages the messaging over phone, WAN and internet. This interface 542 employs multiple personality modules for each of the different communication protocols required by different POS systems (credit card terminal vs. MICROS vs. POSitouch) or networks (phone vs. WAN vs. internet). The POS transaction interface 542 communicates to the guest identification and authorization stage 543, transactional stage 544 and database 56.

The guest identification and authorization stage 543 handles identification of a guest and passes the guest account information to the transaction layer 544. The guest can be identified via use of a merchant issued loyalty device (magnetic card, bar code or RFID tag), user name and password, information registered by the guest such as phone number or name, or from a guest registered payment device such as a VISA® card. Guest information can include stored value balances, loyalty information (points, visits, rewards) and preferred method of payment through public payment networks (ACH and credit cards). To do this the identification and authorization stage 543 communicates with the database 56 that stores a buyer's identification number, preferred payment information, and payment history. The database 56 includes multiple databases of information. For example, to increase security Personal Identification Number (PIN) information is stored in encrypted form on a separate database from a person's name, phone number, and payment account information. The identification and authorization stage 543 matches the identification number with the identification number taken from the payment device to confirm the buyer's identity and analyzes the buyer's payment history, looking for irregularities or past credit problems, to authorize the transaction. In the event of a transaction using a PIN, the identification and authorization stage 543 communicates with a secure PIN manager (not shown), such as Compaq's Attalla A10000PCI or Thales' HSM7100, which in turn verifies the PIN information with an encrypted PIN database.

The transaction layer stage 544 communicates between the other stages 542, 543, 545, 547 and the database 56. The transaction layer 544 takes the transaction request from the POS transaction interface 542 and the authenticate guest account information from 543 and calls the rules engine 545. Each rule provides either authorization or partial authorization of the transaction request. Any changes to guest account information proposed by a rule, such as changes to wallets, are held in a temporary state by the transaction layer 544. If the request is denied then all values are returned to their original values in the database 56. If the request is authorized, the transaction layer 544 commits the guest account information and a record of transaction request and reply in the database 56. The transactional layer 544 also formats the reply message that is returned to the POS transaction interface 542.

The rules engine 545 gathers all rules in effect by the merchant or restaurant chain. These rules are filtered to find only those rules to the transaction and instant in time. The rule engine 542 limits rules for the specific type of transaction; examples of transaction types are activation, add, redeem, and inquiry. Rules are further filtered to specific guest accounts as some rules may not apply to a specific guest tier (silver, gold, platinum) or guest card template. In addition, rules are filtered to the time period and restaurant location; a rule may only apply to a single store or a region of stores for a specific day or part of day. Rules are run in sequence where the output of proceeding rules can be used by those that follow. The rules engine 545 employs transactional limits and daily limits if specified. The rules engine 545 includes an interface for defining specialized messages that are returned to the POS such as cashier pop-up messages. There are real-time rules that are processed in less than a second and those that run on a periodic schedule. These rules enable one to customize the system 50 so that a restaurant can generate custom tailored interactions with their guests. The rules are callable by name, can be added, deleted and modified, chained together and customized (e.g., regional specific rules). The rules are real-time in that they are loaded for the card and merchant and run real-time.

The rule scheduler 546 runs periodic rules, specific scheduled tasks, and turns on and off rules according to a rule schedule. Example of periodic rules are dormancy rules that run at the end of a month and apply a dormancy fee to guest gift cards that have not been used for a merchant defined period for example, 24 months. To meet a restaurant's requirement for granting double points on Tuesday between the hours of three to six in the afternoon, a rule schedule is defined in the merchant creation interface 549 or the maintenance stage 548. The rules scheduler 546 evaluates the schedule and on Tuesday 3pm turns on the double points rule and then off at 6 pm.

The payment manager stage 547 provides for direct access to the payment networks (e.g., Visa or other payment card networks, ATM, ACH, or other networks), and allows for the use of an electronic wallet. An electronic wallet is a small software program used for online purchase transactions. Automatic Clearing House (ACH) transactions may be used to move money for gift card transactions between franchisees and franchisor, or between two franchisees. In addition, ACH transactions can be used to move money from consumer to restaurant for food purchases in combination with a card and secure PIN. The payment manager also processes pre-paid and credit accounts extended by a restaurant to their guests also referred to as stored value and in-house charge respectively.

The merchant creation stage 549 enables personnel to set-up the rules engine 542 to operate with restaurant system 20, according to the database 23 according to the menu item hierarchy 230. The merchant creation 549 offers a web browser interface to set-up stores, users, payment processor information for credit card processing, bank information for ACH movement of money, magnetic card information, rules, rule schedules, e-mail templates and other aspects of the application and hosted service.

Buying and Storing Product Example

Many gift card systems allow the cashier to add value to a card and card account from the POS, store the value and redeem the value at a later date from the POS. System 50 goes further by allowing the cashier or server to add products or menu items to the card and card account from the POS. The products can be stored on the account and redeemed at a later date at the POS.

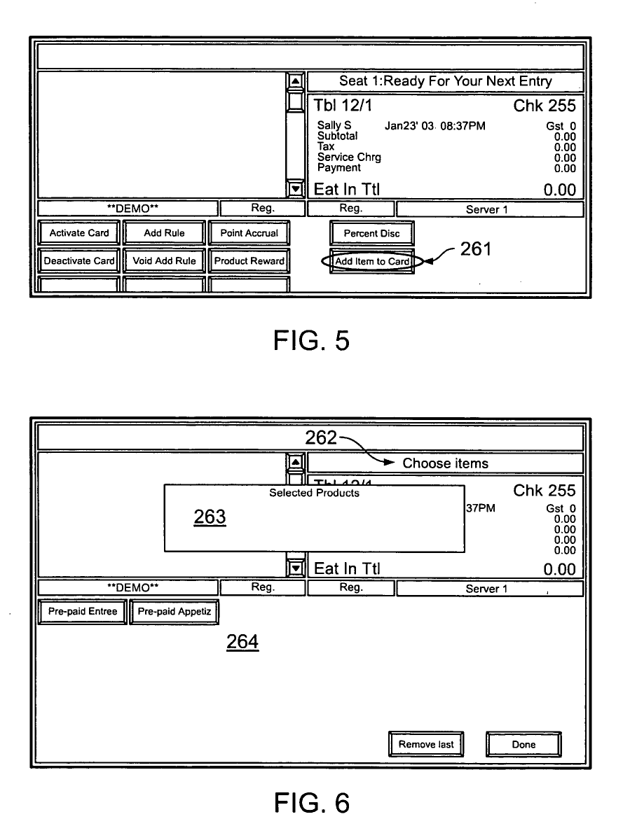

Referring to FIGS. 5-12, exemplary graphical user interfaces (GUIs) used in an example transaction of adding stored product to a card and redeeming stored product from the card are shown. As shown in FIG. 5, a Cashier/Server presses a graphical button 261 to add product items to the card. This button calls for integration and generates a new screen.

As shown in FIG. 6, software integration generates instructions for cashier 262, new buttons or menu to select products to add 264, and visual indication of what items have been purchased in window 263. The number of buttons 264, the names, and order are defined by on the system 50. The integration on the POS requests this information from the system 50 via a loadmap message. The loadmap message is derived by information defined in the database 56. The merchant creation interface 549 is used to define “wallets” that can be sold at the POS. The loadmap request from the POS triggers the rules engine 545 which determines which of these pre-paid product wallets can be sold at that store at that time. The loadmap defines the name of the button and the reference identification of the corresponding wallet in the database 56. The use of loadmap allows centralized maintenance of the hosted system 50 via a web browser and automatic update across multiple store locations in a matter of minutes.

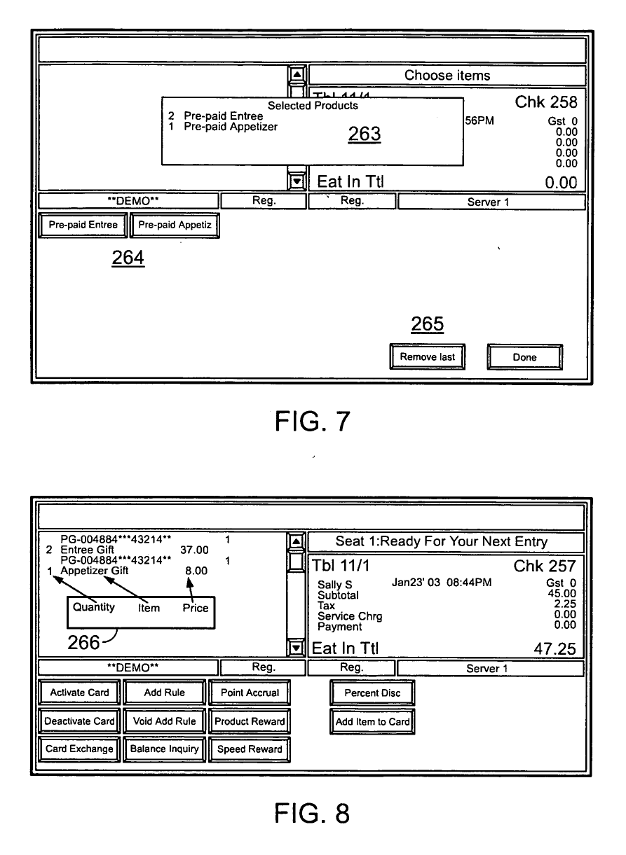

As shown in FIG. 7, the Cashier/Server chooses items to add to the card using buttons 264. In this example, the Pre-paid entrée button has been pressed twice and the Pre-paid appetizer button once. Visual feedback of the selections are presented to the cashier in window 263. The cashier can edit these selections. The Cashier submits the transaction (presses “done”) 265 and is instructed to swipe the guests card 29. The POS integration sends a message to the system 50 to add these items to the card. The system 50 responds to the transaction, verifies account information, runs pertinent rules and updates wallets, as appropriate. The system 50 replies with a message to authorize or deny the transaction and provides the POS system 20 with the menu item information to insert into the check.

As shown in FIG. 8, these menu items are insert into the check 266; they match the quantities and the pre-paid product items requested by the cashier. The names and prices in 266 are based on the menu item returned by the system 50 and can be changed in the local POS system database 23.

When the customer pays for the check a receipt prints indicating what was purchased, tax, method of payment, and card account information and balances, a special guest receipt can print without pricing to go with the card as a gift notification for the card recipient,. The POS integration sends a synchronization message for check level reconciliation, and if an error is discovered with the transaction, e.g., the check was canceled and not paid for, added items were voided, or items were lost at time the check was closed, then the system reports an error. Errors can be automatically or manually reversed. The manual reverse functionality is available in the maintenance and report stage 548.

The account associated with the card (or other ID device) has the product/rewards. The account information can be displayed on merchant reports 46, to the customer via web 42, IVR 30 or at the POS terminal 24. The card 29 can be given to another person who can use it to redeem the pre-paid products or free rewards.

Redeeming Stored Product Example

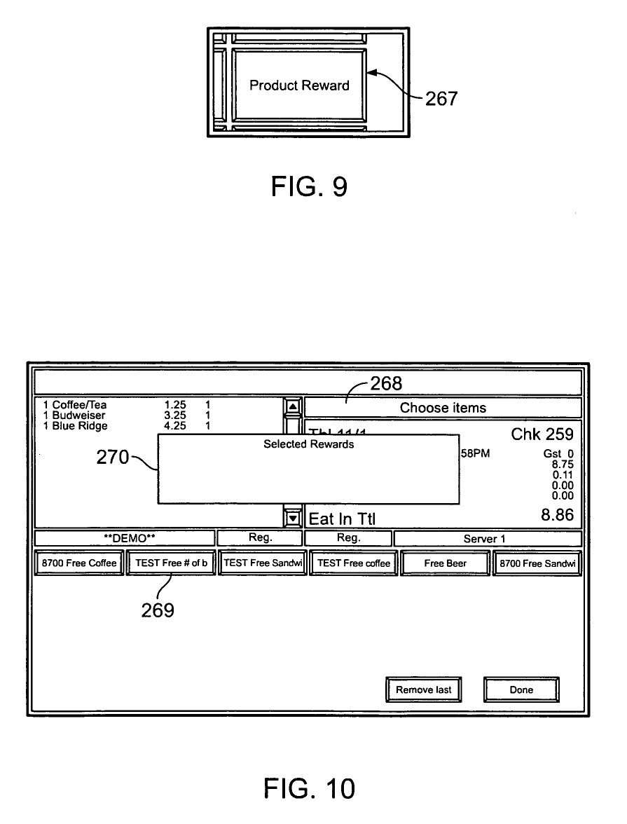

As shown in FIG. 9, the pre-paid product items can be redeemed at the POS system 20. Menu items to be discounted in part or full should first be entered into the check so that they can later be redeemed prior to payment. To redeem the pre-paid products or product rewards, the cashier/server presses the appropriate button 267.

As shown in FIG. 10, the software integration generates a new screen with instructions for cashier 268, buttons 269 or menu to select products to redeem (defined PXS centrally), and visual indication of what items have been selected for redemption in window 270. The redemption buttons 269 are dynamically generated by the system 50 and communicated to the POS integration using the loadmap messaging. The number, names and order of buttons are defined by the system 50 based on the definition of wallets in the database 56 and based on an evaluation by the rules engine 545 of which wallets are redeemable at that time and at that location. In addition, the database 56 as defined using the merchant creation interface 549 determines whether the wallet redeems a specific menu item, an item within a family group, a menu items within a major group or any item within all items. The loadmap also communicates to the POS integration the wallet reference identification to be used to request a redemption from the wallet and the corresponding menu items in the POS database 23 that can be redeemed.

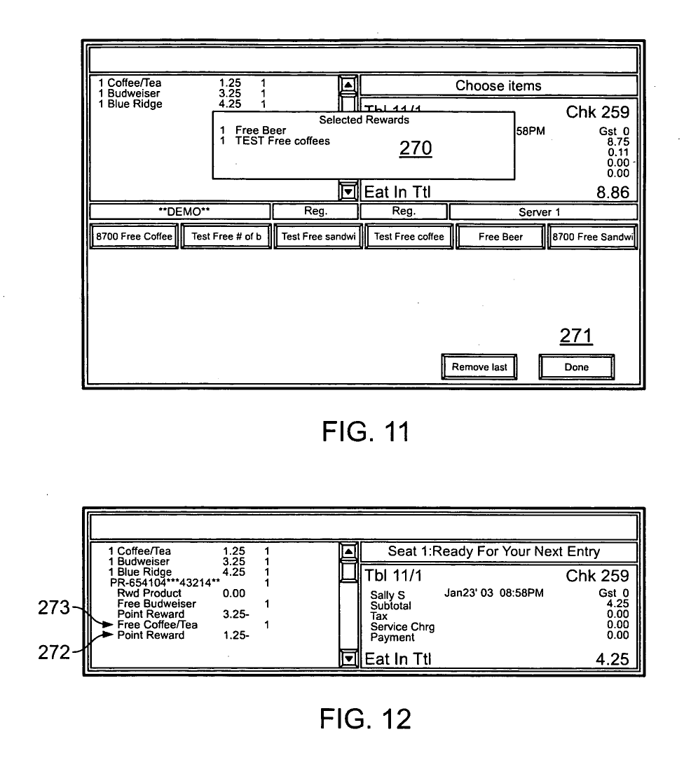

As shown in FIG. 11, the Cashier selects items for redemption by pressing buttons 269. Each button 269 pressed adds to selected rewards. The Cashier can edit the selection list in window 270. The Cashier submits the transaction by pressing “Done” 271 and is instructed to swipe the card 29 or enter identification information.

The POS integration verifies the request (check actually contains the items requested). If no item in the check matches the definition of the button then no redemption message is sent and the POS integration alerts the cashier that there are no items in the check that match. If there are discountable menu items, the POS integration sends a redemption message via the controller to the system 50. The redemption message may include a redemption of multiple items from the same wallet or multiple items in multiple wallets. The system 50 processes the transaction. The system 50 authenticates the guest, applies applicable rules for the time, account and store. If a rule allows redemption of the wallet and the account has value in the applicable wallet the guest's wallet is decremented and the request is authorized. Rules may deny the request, limit the request to available amounts in wallets, limit according to transaction limits, limit according to daily redemption limits, or authorize in full. The POS transaction interface 542 generates an appropriate authorizing reply message to the POS system 20.

As shown in FIG. 12, the POS integration parses the reply message. The reply message determines the number of items, the amount of the item and the discount object in the POS database 23. The amount of the item to be discounted can be an entire item, a percentage of an item, dollars off of an item or weight (lbs or kg) off of an item. The POS integration reviews the check for all appropriate items that match the wallet definition. In the example, a Free Coffee is defined as a menu item and Free Beer is defined as the family group beer. There are two menu items in the check that belong to the family group beer; they are Budweiser or Blue Ridge. The POS integration determines which of these two menu item should be redeemed. A configurable setting determines whether the POS integration uses: i) lowest price, ii) highest price, iii) first one entered, iv) last one entered or v) the next to the highest price for a buy 1 get 1 free reward. In the example, the configuration is set to the lowest price so the POS integration discounts the lowest priced item “Budweiser”. The POS integration uses the appropriate discount object number 272 (sent from system 50 and corresponding the correct object in the POS db 23). The discount is inserted with the correct name 273 found for the item and the item's price. The correct synchronization of rewards to discount objects maintains the correct tax treatment, the correct revenue recognition, and correct tracking in POS reports (inventory, revenue, expenses).

When the customer pays for the check a receipt prints indicating what was purchased, rewards redeemed, card, tax method of payment and card account balances. The POS integration sends a synchronization message for check-level reconciliation. If an error is discovered with the transaction, e.g., the check was canceled and not paid for, added items were voided, or items were lost at time the check was closed, then the system reports an error. Errors can be automatically or manually reversed.

Manual errors and fraud that could be made by the cashier have been completely removed from the process. The merchant is guaranteed that the execution of the program matches the intent.

Stored product cards have several advantages over existing industry standard stored value (or gift cards). Some examples of situations where a dollar based stored value misses the mark of the gift are:

(1) A teenager is going to a party and wants to get a music CD or computer game. The teenager's mother often shops for this gift, but does not know what type of music or game their child's friend likes. They would like to give a gift at Best Buy that says “Pick-out your favorite CD”. With a gift card they must try to determine what dollar amount will pay for a CD and the gift card they give says “Here is $20.”

(2) A business manager wants to give her hard working employee a dinner for two in recognition of extra effort. This is a complex task with a gift card. The manager has to determine what the prices are for appetizers, entrées and deserts to see what a dinner for two might cost. This gets converted into a dollar value, perhaps $75 at a low-end restaurant and $300 at a high-end restaurant. The manager gives the card to the employee with the intent of saying “you did a great job, let me buy dinner for you and your spouse”. However, the message may come across as “Thanks for the work; here's $75.” When the employee uses the card, they have to be thinking about whether the items they purchase are within the dollar limit of the card. They don't want to leave extra money on the card and they may not want to have to pay for excess out their own pocket.

The system 50 provides a solution for the above problems by putting actual product items onto the card—a stored product card. This is our general term, but does not restrict the application to a card. A cell phone, phone number, thumb print could be used as an identification device connecting the POS system, call center, web site, CRM or other system to a central database and software system.

This allows the merchant the flexibility of offering item-based promotions instead of dollar based promotions to gift card sales. Examples of the use of stored product in combination with stored value would be: “Add $50 to your card and receive a free appetizer.” Among the benefits are:

(1) This appears more like a promotional gift rather than a discount.

(2) The merchant can promote specific products or product families based on product margin, product inventory levels, sales goals, getting trial usage, or changing customer purchasing patterns (such as converting a morning coffee drinker to lunch buyer).

(3) Free item treated as non-revenue

(4) Separate tracking of promotional item from the paid for dollars added. This is important for reward expiration and escheat law compliance.

The system 50 provides a simple interface that allows the merchant to add and modify rules, edit rules centrally and automatically deploy rules to all locations, and be specific to a store, group of cards, day and/or time period.

In addition, a merchant can use stored product instead of adding stored value to a card, creating a stored product to the card. In the restaurant example, a dinner for two is purchased and added to the card. This is on a fixed card with predetermined amounts or a variable card where the customer requests exactly what they want. It is possible, for example, for the customer to request: up to $35 off a bottle of wine, 2 appetizers, 2 entrées and 2 deserts. The POS generates the appropriate total to charge the customer, sends the message to the back-end system for storage and prints an appropriate receipt. In the Best Buy example above, the gift for the teenager could be “your choice of 1 music CD” and “one XBOX game.” With the present system, products or rewards can be added, stored and redeemed as:

(1) $ or % off a whole check

(2) Number of items or % off an item within a category

(3) Number of items or % off an item within a family

(4) Number of items or % off a specific menu item or SKU.

(5) When more than one item is found to match within a check, the system can be configured to choose the highest priced, lowest priced, first entered or last entered matching item.

The present system offers some of the following benefits over dollar-based stored value:

(1) The customer can buy a more thoughtful and specific gift

(2) The form of the gift more closely matches the intent

(3) The recipient does not see the exact dollar value that was spent by the giver

(4) It is easier for the merchant to promote the card without creating the marketing impression of discounting. As an example, the restaurant can generate special dinner-bundled pricing or price-specific families below their average price without the recipient perceiving the restaurant was discounting.

(5) The giver and receiver don't have to worry that the amount given perfectly matches the desired purchase. The recipient can purchase the lowest or highest priced entrée without having to worry about leaving unspent money on the card or having to pay for the excess themselves.

Storing the Guest's Favorite Order Example

The system 50 can be used to save a guest's favorite order, store it with their account information, allow them to review it via the web, and retrieve their favorite order from a POS system in another restaurant location.

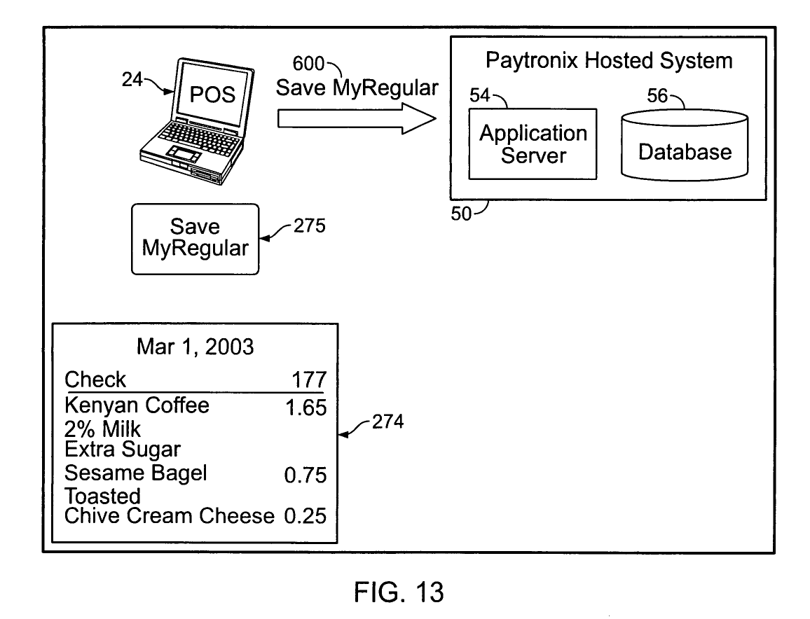

As shown in FIG. 13, the cashier enters a guest's order into the POS terminal 24. The guest's order information 274 may include menu items “Sesame Bagel”, modifiers “Toasted” and condiments “Chive Cream Cheese”. The cashier hits a button 275 that calls the POS integration event “Save MyRegular”. The POS integration requests a card swipe or other guest identifying information and packages the contents of the check in a “Save MyRegular” message 600 and send this messages to the system 50. The system 50 identifies and authenticates the guest and saves the check information in the guest's account record in the database 56. The check items are stored in such a way that names, POS database identifiers, number of each item, and type of item (menu vs. condiment). In addition, the stored information preserves the association between modifier to menu item and condiment to menu item; for example, the sesame bagel is toasted.

The stored data can be retrieved by POS and interfaces including merchant web, guest web, and IVR. The system 50 can present the status of having one or more favorite orders and the save and get transactions.

Retrieving the Guest's Favorite Order Example

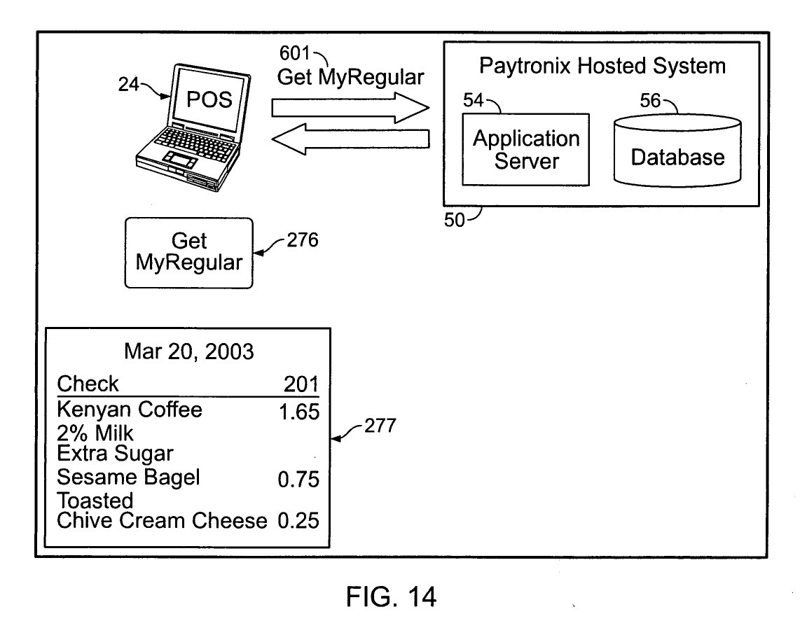

As shown in FIG. 14, the guest enters a different restaurant location on a later date requesting their favorite order. The cashier presses a button 276 on the POS terminal 24 which invokes the POS integration event “Get MyRegular”. The POS integration request a card swipe or guest identifying information and sends a “Get MyRegular” message 601 to the system 50. The system 50 identifies and authenticates the guest and retrieves the guest's favorite order in the database 56. The POS transaction interface generates a “Get MyRegular” reply message that is sent to the POS terminal 24. The POS integration parses the reply message and inserts the appropriate order detail into the check 277. The POS integration maintains the number of items, the object identifier in the POS database 23. In addition, the stored information preserves the association between modifier to menu item and condiment to menu item; for example, the sesame bagel is toasted.

It is possible to overwrite a MyRegular order from the POS terminal. It is possible to add additional MyRegular orders from the POS terminal. A guest can have a breakfast favorite order and a lunch favorite order. If the guest more than one MyRegular exists, then the Get MyRegular reply message contains all MyRegular orders; as an example, both the breakfast and lunch favorite. The cashier is prompted that multiple MyRegulars exist and the cashier can select between these with guest assistance.

Discount Types and Uses Example

In our stored product system 50, stored product can mean any menu item in a restaurant's POS database. And each one of these menu items can be treated in different ways, e.g., as a $, % or # of item discount. Examples for product rewards could be:

a. 2 Free games of bowling

b. 3 free hours of billiards

c. $6 off of darts

d. 1 Free entrée

e. 50% of an appetizer

f. 1.50 lbs of coffee

The system 50 provides an easy to use interface that can handle the addition of more than one type of product or reward into a check and multiple amounts of any item. This graphical user interface (GUI) can be managed centrally on a back-end server and automatically distributed to each POS in all store locations. The system 50 inserts menu items into the check database and POS database that have the right menu item definitions, such as name, price, and tax classification. The system 50 allows for central management of the definition of the inserted menu item and a gift receipt that contains the product information, not the prices.

The interface handles the redemption of more than one type of product or reward into a check and multiple amounts of any item. The system 50 uses a single source of code that can handle many different types of merchants without any changes or customization to the code.

The system 50 verifies that the product or rewards are actually in the check and the POS does not allow the redemption of a free entrée if no entrée is purchased in the check. The system 50 can find the right entrée to discount per the merchant's request (i.e., first, last, highest or lowest) when there are more than one entrée in a check.

The system 50 can insert a discount into the check and POS database with the correct discount object number, and reference line and price that match the correct purchased item on the check. For example, the entrée discount should be the correct discount for food (tracking and tax class) and it should have a reference line that says “London Broil” and the price of the “London Broil” menu item.

In the system 50, messaging handles balance inquiries from the POS or web site so that they send only the wallets that the merchant desires to be customer visible. A wallet is a small software program used for online purchase transactions. Many payment solution companies offer free wallet software that allows several methods of payment to be defined within the wallet (for example, several different credit cards).

In the system 50, variable length messaging enables wallets coming with definitions about their contents, such as name, type ($,%), and item class (menu, family, category, whole check).

In the system 50, variable length messaging explains to both the POS and PXS what a product or reward means.

In the system 50, variable length messaging handles more than one wallet in a message, different types of wallets in a message, and is configurable such that, for example, it can go from stored $ transactions one day to stored product transactions 1 hour later with 10 product wallets, all of different types and definitions.

The system 50 utilizes real-time rules and batch rules. These real-time rules allow more possibilities for different types of rules, are able to act on different input and output wallets, and can have multiple inputs and output wallets. The real-time rules verify that rules executed properly, executed in order and executed correctly. The real-time rules can be edited centrally and are distributed for execution in near real-time.

The system 50 implements check-level reconciliation. Prior systems used batch reconciliation. In batch reconciliation, transactions from a shift or a day are sent as a batch at the end of the shift or day. This file of what the POS thinks are valid paid for transactions is compared to a file of what the central database thinks are valid paid for transactions. Some discrepancies are automatically reconciled and others are reported for manual reconciliation. A batch based system makes sense in the credit card industry where money does not move between parties for one or more days (i.e., typically after a reconciliation period.), but has a relatively long time period (days) to find and reconcile discrepancies.

However, in a stored value or stored product system like the system 50, the value on the card can be used within this shift or day period. This generates a significant window for fraud or training errors. The system 50 implements check-level reconciliation. When a check changes state—canceled, closed through payment, or sent, a summary message about the transaction on the check is sent to the central database. The POS integration identifies any lost, deleted, voided or unexpected transactions. This gives the back-end database the ability to define the exact state of a transaction at the time a check changes state (typically a matter of minutes vs. days). The central database can report on this to catch fraud and correct training issues. In addition, the central database offers both manual and automatic reconciliation tools to resolve discrepancies.

As discussed above, as an example, a loyalty reward programs is a program offered by a seller or merchant that rewards buyers for their patronage to increase buyer loyalty. Reward programs may include: product discounts and coupons, points associated with a purchase that can be used at the store or other places like frequent flyer miles, special offers, invitations to special events or rebates tied to purchases. A Loyalty Card is a card that is issued by a merchant to identify the buyer as part of a loyalty rewards program. A loyalty card given to the buyer usually has the merchants name printed on the card and a unique account number stored on the card, often utilizing a bar code or magnetic stripe.

Web-based Management of Rules

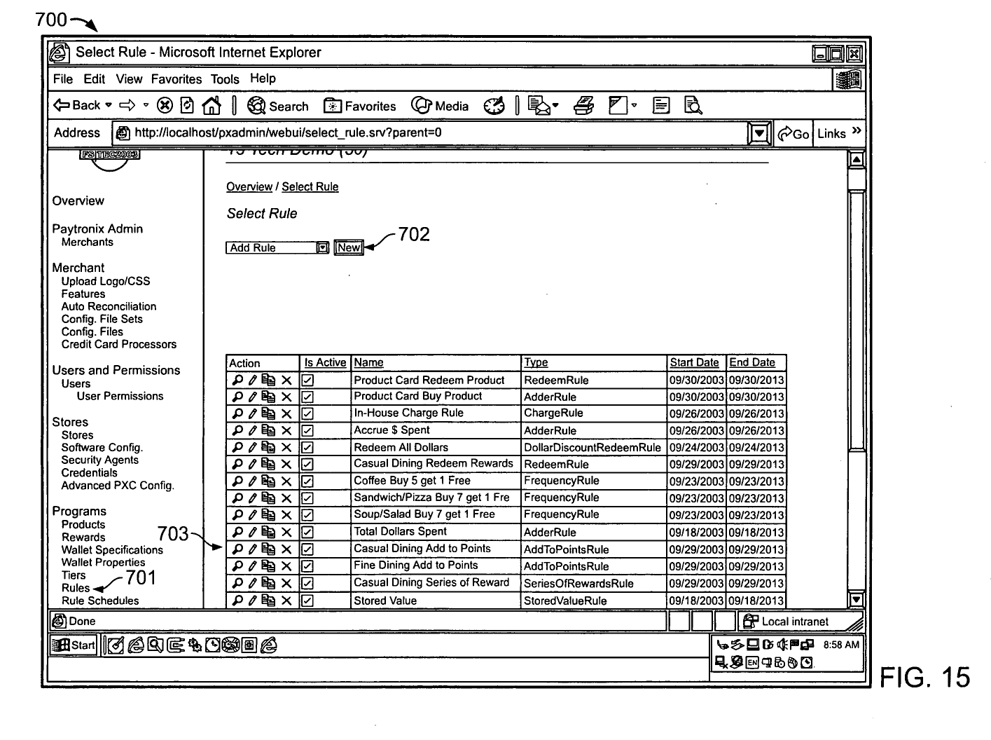

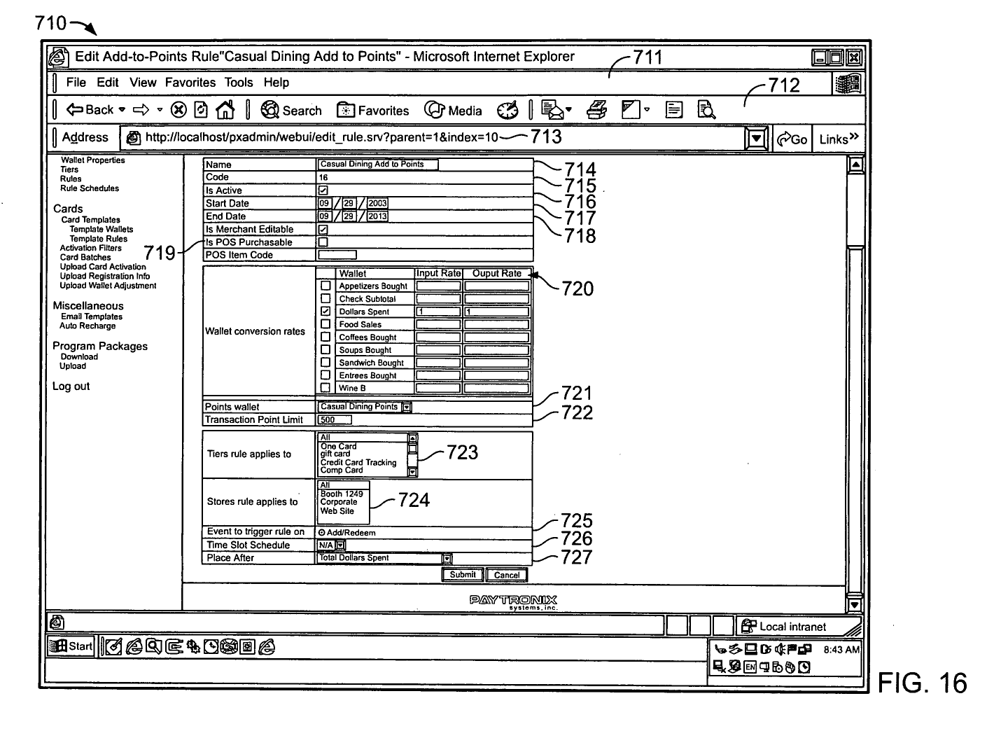

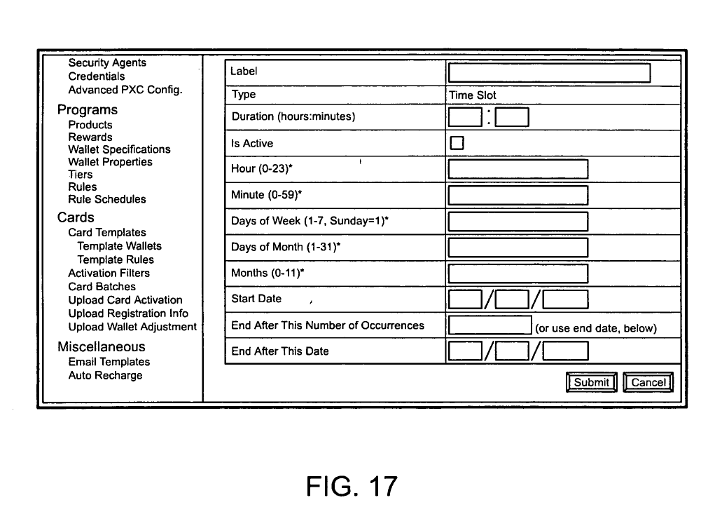

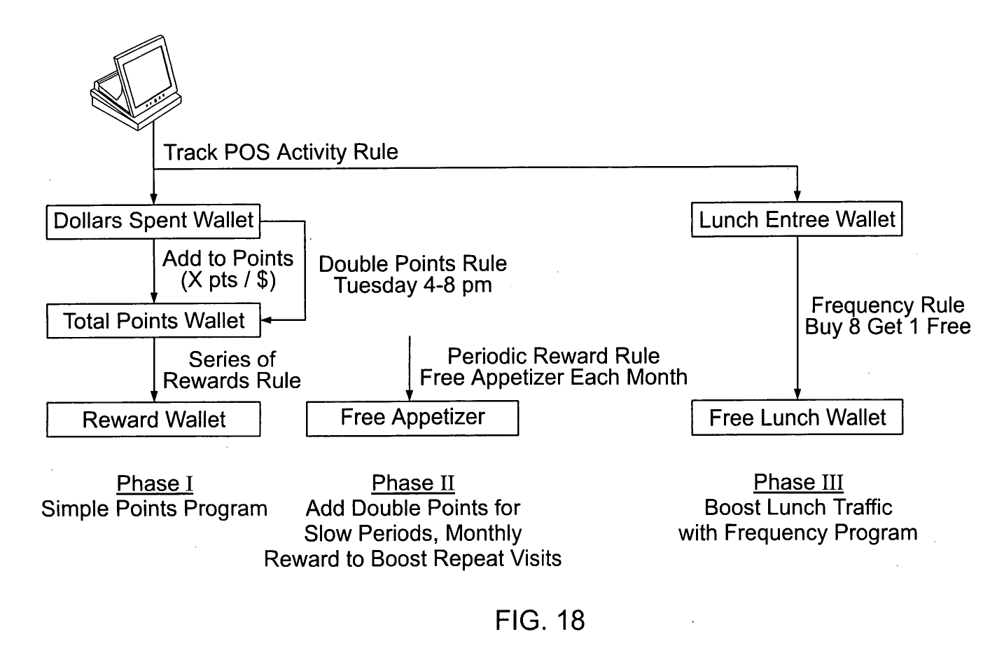

As shown in FIG. 15, the merchant creation interface 549 is accessible by a web browser. The user interface 700 has navigation links to different portions of the merchant and program definition. One link 701 brings the user to the set-up and maintenance of rules shown in screen 700. The user has the option of creating a new rule 702 from the library of available rule templates. The user can see the list of existing rules that have been defined and a status of their use along with the ability to select a rule for view, edit or copy using graphical icons 703.

As shown in FIG. 16, the rule template interface 710 provides entry fields for user input and edit. The user can define a rule name 711 so that multiple versions of the same type of rule can be differentiated. The rule shown is an add-to-points rule where a items purchased or dollars spent at the POS terminal 24 can be accumulated with a multiplier to another points wallet. A second add-to-points rule might be used when a merchant uses a double points for specific store locations and time periods.

The system 50 assigns an index for each rule so they can be uniquely identified 712. Rules can be turned on and off manually with the active flag 713 or automatically with a rule schedule 726. A date range 714,715 can be set so that rules can be set-up in the system and verified before the time they are expected to execute and be deactivated automatically. The setting 716 determines whether the rule is editable by the merchant in the management and reporting interface 548. If checked the same interface page 710 is available to merchant users with applicable permissions.

Some rules can actually be sold at the POS terminal 24. An example of a salable rule would be membership into a monthly reward “free coffee of the month” program for $10. The POS purchasable setting 717 must be checked and a code 718 defined which matches the POS integration configuration. When the loadmap request is made from the POS terminal, the rules engine 545 will evaluate this rule and add this rule by the identifier code as being sellable. A specific button on the POS interface invoke a POS integration event to add the rule. An add rule message will be sent from the POS system 20 to the system 50.

The next section of the rule 719 defines the wallets and rule parameters. Wallets can be selected or deselected as pertaining to the rule. In this case, the dollars spent wallet is tracked and 1 output point is given for every 1 input amount. The sum of all selected input wallets multiplied by the output divided by input ratio is added to the points wallet 721. The transaction can have a maximum limit as defined by field 722.

The next sections of the rule template page 710 defines the situations in which this rule applies. The program tiers available are define in 723. The selection of tier makes it possible to create rules that apply to Gold and Silver tier members, but not to a lower tier like Bronze. The applicable stores are defined in 724. In addition a rule can be defined in area 725 to apply to specific types of events. This rule only has the option for the adding or redeeming transactions. Other rules have event triggers for guest web registration, card activation and other events.

The order of the rules is defined in field 727. The ordering of the rules is critical and different program results can be achieved by simply changing the order of the rules.

In addition to the above selections, rules can be attached or not attached to specific card templates. It is possible to create programs with two different types of cards each with different rules or sharing the same rules for ease of system maintenance.

The above information not only defines the execution parameters of the rule, but also allows for targeting of the rule itself to a specific store or set of stores, time range (start and end), and tier (e.g., bronze, silver, gold, new member, etc . . . ). This provides the capability of targeting a rule to a very specific group of users, e.g. only registered users (tier=registered) who shop in Denver get access to the Instant Wins Rule). Very complex programs can be built by layering targeted rules on top of general program rules. Other rules available in the rules library are shown below:

Sample from Library of Rules

Add Rule (tracks purchases at POS)

Add to Points rule (converts POS purchases to different types of points).

Auto Recharge Monitor rule

Auto Recharge Processor rule

Bingo rule (incentive for transaction or cumulative purchase behavior)

Birthday Rule (creates monthly or bimonthly rewards for birthday's of guests and their family members)

Charge rule (controls in-house charge)

Conditional Transfer rule (convert offers to rewards when items are purchased)

Dollar Discount Redeem rule (redemption against multiple discount $ wallets)

Dormancy rule ($X fee after Y months of no use)

Dormancy expiration rule (Expiration X months after activation)

Extra Item rule (Incentive for increased stored value purchase)

Frequency rule (Buy X get Y free)

Increment rule (If X>Y get Z)

Instant Wins rule (X out of 1,000,000 win X reward)

Periodic add rule (typically used for manager cards—add X to wallet Y up to a limit of Z)

Periodic Fee rule (applies fee after period)

Periodic Reward rule (used to give monthly rewards in a membership program)

Redeem rule (redeem rewards with full or partial authorization)

Reward from Monthly Points rule (converts special offer to a different reward each month by store)

Reward from Points rule (satisfies a redeem reward request by converting from a points wallet)

Rule Activator rule (turns on other rules when specific events occur)

Series of Rewards rule (As guest reaches higher point levels they receive additional rewards)

Series of Rewards with Odds (At X points guest gets a reward which is determined from a list randomly)

Set Tier rule (set tier at time of web registration or other event)

Stored Value rule (full or partial authorizations of stored value)

Strict Redeem rule (redeem rewards of full authorization only)

Strict Stored Value rule (no partial authorizations of stored value)

Sweepstakes rule

Tier Evaluation rule (Change guest tier based on behavior)

Top Threshold Reward rule (ladder of incentives for stored value purchase)

Transfer rule (transfer values between wallets)

Visit Tracking rule (track multiple transactions over X minutes into a single visit)

Welcome Back rule (Identify guests at POS who have not been in for X days)

Generating Complex Combined Loyalty and Gift Programs Example

The system 50 provides a unique capability of providing gift, loyalty and marketing promotions all on a single card or card free guest account. The building blocks of complex programs are: wallets, rules, rule schedules, tiers and card templates.

Wallets are used in our loyalty programs to store money, rewards, points and to track transactions. Loyalty program wallets are attached to each customer's loyalty card when the card is activated at the register. Like a physical wallet, a wallet can hold money for a customer as stored-value. Wallets can also hold a customer's program rewards, such as points or products earned. In addition, customer wallets track information about each customer's purchasing behavior, such as dollars spent per visit, and items purchased.

Rules are defined for each loyalty program that a merchant offers. The rules engine identifies customers by their wallet information and rewards them for purchase activity in real-time during each purchase transaction.

For example, a frequency rule can track coffees purchased in a “coffees bought” wallet. When a customer purchases his 9th coffee, the frequency rule adds a reward to the “free coffee” wallet during the transaction. The customer has earned a free coffee, and the updated reward activity is printed on the customer's receipt.

With our library of rules and wallets you can build very complex, custom loyalty programs in a modular and flexible way.

After initial program launch, you may want to track more information, change the program rules or add new rewards for your customers. System 50 makes it easy to add both rules and wallets to existing programs, automatically updating all customer card accounts and POS software configurations

Dynamic Messaging Example

The system 50 is adapted to use variable message lengths in PXC-PXS messaging. Variable messaging allows the user to easily make changes to message formats. The message format includes a version information and this field is assigned an appropriate value. A major.minor version number can be used. It is possible to handle versioning of message formats. The process for packing and unpacking messages is data driven and it allows one to embed one message within another.

The message, in one example, uses extended markup language (XML). XML Data Binding is a specific XML technology that provides transparent conversion between XML documents and Java objects. By using such a technology, we allow developers to concentrate on message processing business logic rather than the details of packing and unpacking XML-based messages (XML parsing/generation). Various products can be used, such as Sun's JAXB, Exolab's Castor, and SourceForge's Quick (SourceForge). Apache SOAP (Apache XML Project) is not a true XML data binding solution, but does support some JavaBean encoding and, if XMI is used, supports automatic marshalling and unmarshalling of arbitrary objects.

The XML Data Binding tools include both run-time tools (libraries to convert between specified XML document formats and Java classes) and design-time tools (given a specification such as a DTD or a class definition, create all the associated components).

The system supports a web services approach for accessing our server functionality (e.g., as the “API” for merchants to communicate directly with PXS).

The messaging system is implemented to support multiple message versions simultaneously with a minimum of engineering effort. Pack/unpack processing does preliminary processing to determine the message version and then delegates further processing to version-specific code. With each new message version release old messages are “shoe-horned” into the current version of the product (e.g., database schema, authorization and workflow issues). Between the messaging packing/unpacking layer and the business logic layers there is a translation layer that deals with these issues.

XML-based messages are inherently verbose. Since we are using secured sockets layer (SSL) for secure message transport, we perform high level compression (such as using Java ZipStream) before SSL encryption occurs.

As discussed above, our system 50 provides POS/PXS synchronization. The POS uses Load Map Data for Product reward list, Point Accrual and Stored Value Operation. The idea behind using it from Load Map information is that it is already stored once in PXS Database. It is desirable not to redefine the values again in PXC or in POS. This design provides all the wallets required for add as add wallets and all the wallets required for redeem as redeem wallets and PXC doesn't have to have any special code for any wallets. All it has to do is, item to wallet and wallet to item conversion.

Also we want to make sure that the information that the POS has remains current. For this we implement the periodical reloading of the Load Map.

There are three options:

(1) Generate a separate addRedeem query reply object with wallet name. It can be derived from addRedeem reply object.

(2) Modify addRedeem reply object to have wallet name in it.

(3) Use Load Map Reply object which is used between PXC and PXS.

In Option 1: It is the only message between PXC and POS so we don't have to create the XML messaging.

In Option 2: It affects XML messaging because addRedeem reply is used everywhere.

In Option 3: The advantage of this option is in the future if we introduce more information between PXC and PXS then POS can also get it with out changing message objects.

Instead of using stored procedures, the system 50 runs the rules engine to identify all the rules and wallets. Since it uses the rules engine it can create all the possible add wallets and all possible redeem wallets. It can also identify all consumer visible wallets and all consumer non visible wallets. PXS sends this list to PXC and PXC doesn't have to have extra logic to understand what add wallets can be used as redeem wallets. POS receives this list as part of addRedeem Query reply and display only consumer visible redeem wallets as part of the product reward list.

We also implement a polling method instead of a notification method. Anytime the POS thinks it needs to reload the Load Map, it will do so. This generates millions of worthless messages per month, but since these messages are small and confined to the local network, they do not seem to be a problem. We reload the Load Map every time we initiate or reinitiate the communication with PXC or PXS (i.e. at Startup, and any time we think that PXC or PXS are down). We do not reload the Load Map for every transaction. Instead we tag the Load Map that we receive from the PXC with the time stamp on which we received it. We set an amount of time, specified in minutes, which is a parameter in a Pxconfig.cfg file after which we decide to reload the Load Map. When we get any AddRedeem request from the user, we check the timestamp of the Load Map. If the time on the time stamp+Amount of time for which the Load Map are valid is smaller than the time now, we reload the Load Map. If the Amount of time specified on the Pxconfig.cfg is 0, we never do a periodical reload of the Load Map (However we will reload it in other situations).

Thus, PXS uses rules engine identify rules and wallets, the PXC eliminates additional logic to find map add and redeem wallets, and the POS eliminates a local configuration file parameters and uses load map reply.

POS Synch-reconciling Between POS and Database Example

The system 50 reduces redundant data stored in a POS configuration file, which is already stored in the PXS database, by using load map data for product rewards. POS makes requests for various PX transactions. These transactions are approved by PXS and ready to use immediately by PXS (real time). For some reason if POS loses some of the transaction replies from PXS then PXS and POS are not in sync anymore. It is essential to identify the transactions (replies) which are all not received by POS and provide a mechanism to reverse those transactions at PXS.

What we build for synchronization can also be used for Stored Value at a later stage of the development life cycle.

Some of the differences between the Synchronization feature and the Stored Value feature are:

1. Synchronization is to synchronize between what PXS assumes as POS received versus what really POS received.

2. Stored Value is, if any Stored Value cards are issued in a check (POS Transaction) Customer needs to pay for all the cards before he/she gets to use it. We can compare this feature as an authorization versus settlement in payment processor world. The Merchant can request for many authorizations to collect money from various credit cards but merchant can to use that money only after the settlement occurs.

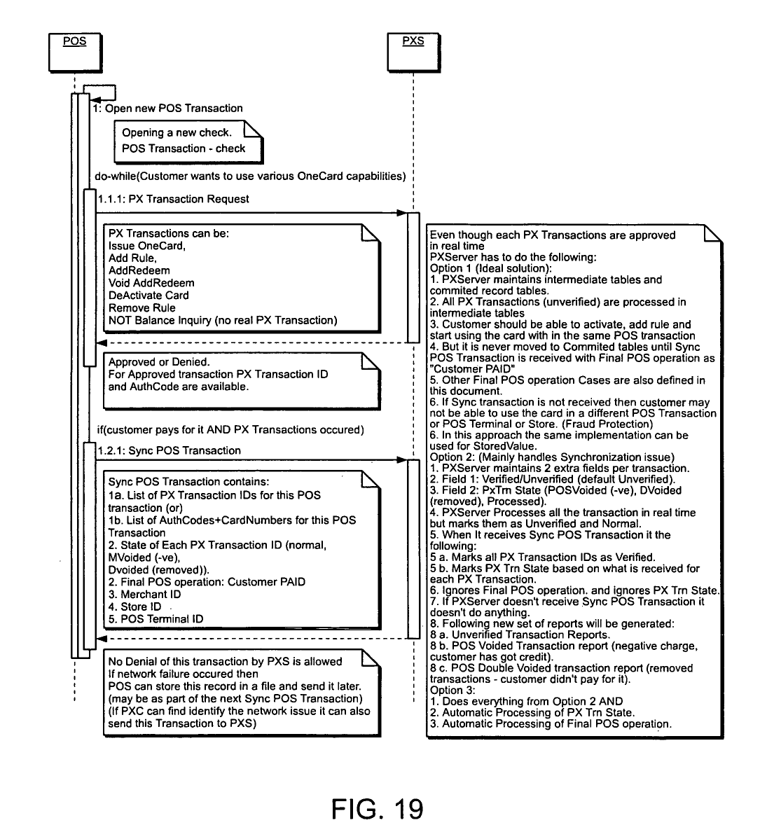

As shown in FIG. 19, a customer paid option flow diagram is illustrated. A Sync POS Transaction includes the following fields

i. MerchantID

ii. StoreID

iii. POS Terminal ID

iv. Operator ID

v. DateTime

vi. List of:

1. POS Transaction ID

2. Final POS Operation (P-persisted, S-settled, C-Canceled)

3. List of:

a. PX Transaction ID

b. PX Transaction State (P-Processed, V-Voided, D-Deleted)

Sync POS Transaction is sent to PXS at the following events:

i. Customer PAID for it.

ii. Cashier Cancelled the POS Transaction (Transaction Cancel of a check)

iii. Cashier decides to store it and ask customer to pay for it later. (Send/Send&Print)

IF POS times out (not received reply from PXS) it can do one of the following:

i. It can store the Sync POS Transaction in a file and send it with next Sync POS Transaction. (The message needs to be formatted in a way it can send more than one POS Transaction, because the same message can be used for Close Batch Command also).

ii. Ignore it.

POS also builds a file of Sync POS Transactions and uses it for Close Batch Message.

In PXC, a transaction detail table has the following.

i. Field 1: Verified Field Values are Null, Verified, NotVerfied. Default: Null.

ii. Field 2: PX Transaction State. Values are P-Processed, V-Voided, D-Deleted.

iii. Field 3: Final POS Operation: values are: Init, Intermediate (Persisted), Final-Settled, Final-Canceled. Default: Init.

iv. Field 4: Settlement: Values are Unsettled, Settled, NotSettled. Default: Unsettled.

When PXS is down it store Sync POS Transactions (IN ORDER) and send it later. IF PXS is down PXC sends a successful response back to POS for Sync POS transaction message. When PXS comes back up PXC maintains a single queue for all terminals and clears the queue before it sends any real time transactions.

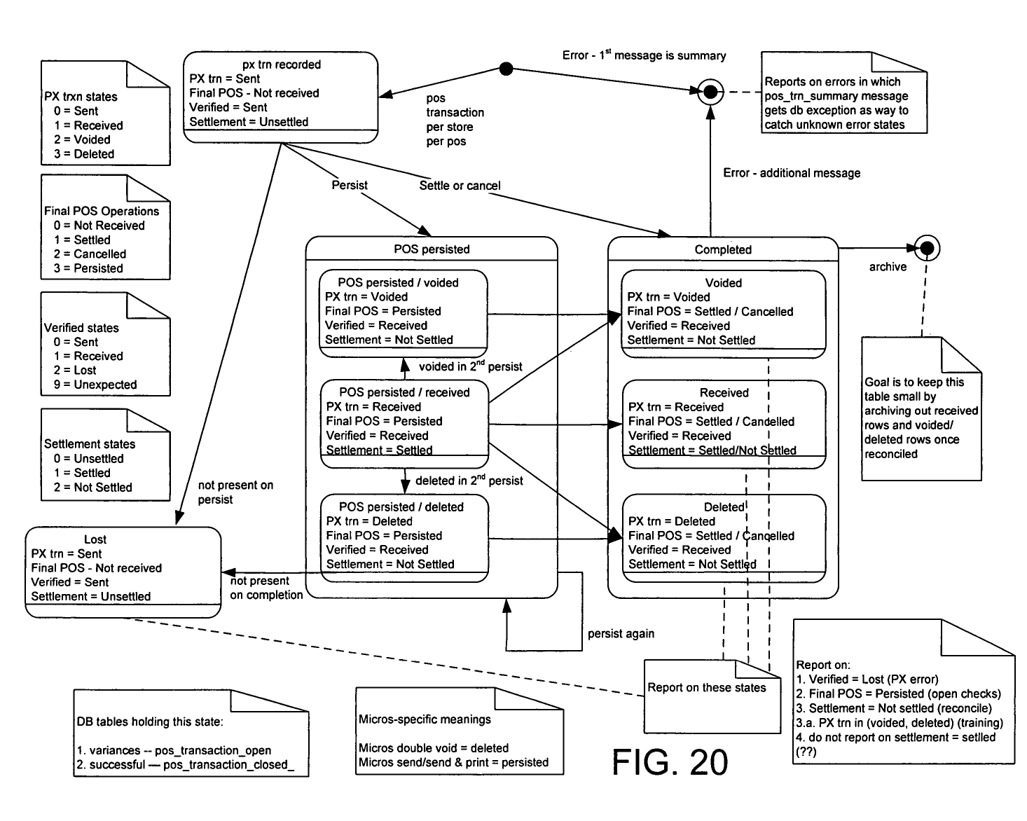

In FIG. 20, a state diagram of check-level reconciliation is show.

The invention can be implemented in digital electronic circuitry, or in computer hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

Other embodiments are within the scope of the following claims.

What is claimed is:

1. A method comprising:
receiving a request for a product;
receiving a unique user identification;
sending the product request and user identification to a database server;
processing the product request and user identification in conjunction with a set of rules in the database server; and
storing the product request on a device associated with the user identification.

2. The method of claim 1 in which the product request is a specific menu item.

3. The method of claim 1 in which the product request is a specific stock keeping unit (SKU).

4. The method of claim 1 in which the product request is a family of menu items.

5. The method of claim 1 in which the product request is a family of SKU items.

6. The method of claim 1 in which the product request is a category.

7. The method of claim 6 in which the category is a plurality of families.

8. The method of claim 6 in which the category is a plurality of SKU items.

9. The method of claim 1 in which the product request is a specific menu item.

10. The method of claim 1 in which the stored product request represents a number of items.

11. The method of claim 1 in which the stored product request represents a percentage discount of an item.

12. The method of claim 1 in which the stored product request represents a dollar discount of an item.

13. The method of claim 1 in which the stored product request represents a dollar discount of a plurality of items.

14. The method of claim 1 in which the stored product request represents a percentage discount of an item.

15. The method of claim 1 in which storing further comprises adding additional product.

16. The method of claim 1 in which storing further comprises adding rewards.

17. The method of claim 1 in which sending comprises variable length messages.

18. The method of claim 1 further comprising performing a check-level reconciliation.

19. The method of claim 1 in which the request originates for a point-of-sale (POS) terminal.

20. The method of claim 1 in which the request originates from remote network terminal.

21. The method of claim 1 in which the request originates from a kiosk.

22. The method of claim 1 in which the device is loyalty card.

23. The method of claim 1 in which the device is Personal Data Assistant (PDA).

24. The method of claim 1 in which the device is payment card.

25. The method of claim 1 in which the device is smart card.

26. A system comprising;
a point-of-sale (POS) terminal having a POS database;
a link to a server database having a plurality of rules; and
a link to a device for uniquely identifying a user and for storing a product representation.
